(19) United States
(12) Patent Application Publication
(10) Pub. No.: US 2007/0165018 A1
(43) Pub. Date: Jul. 19, 2007

(54) COMPUTER SYSTEM

(76) Inventor: Yasunori Yamada, Hadano (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/614,175

(22) Filed: Dec. 21, 2006

(30) Foreign Application Priority Data
Dec. 22, 2005 (JP) 2005-370289

(51) Int. Cl. G09G 5/00; G06F 3/038

(52) U.S. Cl. 345/214

(57) ABSTRACT

A client device used by a user is formed by a PC as a first client and a terminal device as a second client. The terminal device is, for example, a portable type and has software capable of inputting/outputting information to/from a personal computer (PC) and being controlled at a remote place. For example, a plurality of PCs are integrated for management. Data used by the user is not stored in the terminal device side but stored in the PC side. The PC includes, for example, a sub processor and a state of the main body is monitored by the sub processor so as to detect abnormality.

### INCORPORATION BY REFERENCE

The present application claims priority from Japanese application JP2005-370289 filed on Dec. 22, 2005, the content of which is hereby incorporated by reference into this application.

### BACKGROUND OF THE INVENTION

The present invention relates to computer system and operation management method, i.e., a system and a method for operation/use and management of a computer/information processing device such as a PC (personal computer) and an information processing terminal device. In particular, the present invention relates to techniques for computer multiplexing, remote control use, power state management/control, and data/information protection/security.

Conventionally, a computer system used for general office routine processes, business activities, accounting processes, and other jobs typically includes a server (S) for sharing data and a client (C) connected to the server (S). The client contains an operating system (OS), software (application), and data (acquired from the server or created by itself). That is, a so-called client-server model system (CS system) as a conventional general business system is widely used. Especially the client is often a portable PC or information processing terminal device which can be carried by a user outside a company and used outside the office. Hereinafter, the client (client device) may be referred to as “CL”.

As for the computer operation management, JP-A-2002-041348 discloses a method for sharing a bus in a plurality of high-density computers and eliminating an error. However, it describes little about the operation.

Moreover, JP-A-10-269087 discloses a method for monitoring power failure under the operation of the CS method. However, no sub-processor is mounted on each client.

### SUMMARY OF THE INVENTION

In the general computer system configuration in the related art, there is a case that a person who has carried out the client device loses the device or has it stolen or the device fails and the data inside may be broken or leak. These may occur without intention of the user. Especially the data leak may lead to leak of the information on its company as well as the information on other companies and the company may lose the social reliability.

Furthermore, in order to maintain the PC in a preferable state for other than the main job of the user, the user should have sufficient knowledge for the hardware and software of the PC. For this, the user needs a work time for the thing which has little relationship with the main job. That is, an additional time is required for the user and the employer.

It is therefore an object of the present invention to provide a technique to cope with a loss or leak of data when a client device is moved (carried out) in the computer operation management technique and facilitating the operation/management of the used computer.

The outline of the representative inventions disclosed in this application is as follows. In order to achieve the aforementioned object, the technique of the system and method of the present invention relates to a system for operating/using a computer (information processing device) and its management and the object computer including the technical means as follows.

In the technique of the present invention, the CL side of the conventional CS model has a dual structure, i.e., configuration of a first CL and a second CL. For a client device (first CL: first client device) such as a PC conventionally allocated for an individual user, a terminal device (second CL: second client device) which can be connected for communication for remote control is prepared. The terminal device (second CL) basically does not store user data, which is stored in the first CL side. The first CL which is operated by remote control from the second CL is controlled via a communication path (network) so that the user data cannot be carried out outside the company. For example, the first CL is installed in the computer room of a company and the second CL is a portable device arranged at hand of the user. Moreover, when the device (second CL) used by the user has failed or is in an abnormal state, an administrator having skill can check and rapidly recover the device.

(1) For example, this is a computer system having a first computer (first CL) such as a PC allocated for a user for use. The first computer includes a main processor (MP), a sub processor (SP) for monitoring the state of the first computer (at least power supply state), a main power for supply power to the MP, and a sub power for supplying power to the SP. Moreover, the system includes a second computer (second CL) other than the first computer operated/used by the user. The second computer can be connected to the first CL by remote control for communication and remote-controls the SP by sending/receiving a control signal to/from the SP.

The SP always operates when the sub power is turned ON even during halt of the MP by turning OFF the main power. The SP includes monitoring means for monitoring each state of the power supply (main power supply), temperature (temperature of the MP). cooling means (fan, etc., and function failure (OS freeze on the MP during power ON, etc.). When the monitoring detects an abnormal state (power supply failure, high SP temperature, fan stop, OS freeze, etc.), a lamp is lit, a sound is generated, and a message is automatically sent so as to notify both of the administrator and the user. That is, the system includes means for reporting the abnormal state to both of a computer (called a management computer) operated/used by the present system or a computer administrator of a plurality of users and a second computer (second CL) operated/used by a user. It should be noted that a report destination in the report is set depending on the operation system configured by including the first computer.

(2) Moreover, for example, the present system is a computer system including a first computer (first CL) and a terminal device (second CL) communicably connected to the first CL by remote control. User data (data unique to each user) processed, edited, generated, or referenced by the user by using the terminal device is stored in the first CL by remote control. The user has means for operating/using the use environment of the first CL allocated for the user directly from the remote terminal device. The terminal device at hand cannot store the user data and the user data is stored in the first computer side.

(3) Moreover, for example, in the present system, an application program to be used on the terminal device at hand by the user is operated on the remote first CL. The terminal device includes an OS (operating system), an information output (screen view conventionally displayed on the first CL) including display of the screen information from the remote first CL, and an I/O function (or peripheral device I/F function) for inputting the information from the terminal device at hand.

(4) Moreover, for example, in the present system, the OS to be operated on the terminal device at hand by the user is operated on the remote first CL. The terminal device has a built-in function (display software) for displaying (information output) the screen condition and a built-in remote control software (program) for operating the remote first CL and transferring data via the network.

(5) Moreover, for example, in the present system, the SP provided in each of the first CL is normally ON state by the sub power supply or the like and has a function to forcibly turn ON/OFF according to the instruction by the user using the terminal device. Especially as a remote control, according to a report, to cope with an abnormal state, a control signal for forcibly turning OFF the main power supply is sent/received from the management computer or the user second computer to the user first computer SP, thereby turning OFF the main power supply from the SP.

(6) Moreover, for example, in the present system, one or more management computers are arranged on the network. The management computer has a correspondence relationship table (management table) indicating correspondence relationship between each user and a first CL allocated for the user. In response to a connection request from a user computer (second CL), the management computer references the correspondence relationship table and connects the first CL allocated for the user to the user computer which has issued the connection request so that the user can use the first CL allocated.

(7) Moreover, for example, in the present system, the management computer has a user correspondence relationship table. When a user makes a connection request, check is made whether an identifier (authentication number or the like) given from the user side for authentication coincides with the information held in the correspondence relationship table. This prevents an unauthorized use of the computer. For example, if the authentication is unsuccessful, connection to the first CL is not allowed.

(8) Moreover, for example, the present system includes a management computer and a particular combination of computers (second CL-first CL) is not fixed for use by users. Moreover, user data is held in a storage medium (storage device, etc.) on the shared network which can be accessed from the first CL. When the management computer has received a connection request from a user computer, it allocates a computer (first CL) which is not being used by other user at the moment, thereby operating the entire system.

(9) Moreover, for example, in the present system, when the management computer selects a first CL to be used by the user, i.e., the first CL to be connected to the terminal device (second CL), decision is made according to at least one policy setting which is information as judgment reference of allocation/correspondence relationship between the user and the terminal device (second CL), and the first CL. Each policy is set by the administrator in the management computer for management and referenced upon a connection request. For example, the management computer selects at least one of the first CL which are not being used and connects it to the user computer which has made the connection request, thereby operating the entire system.

(10) Moreover, for example, in the present system, the first CL as a control (connection) object from the terminal device are all standardized and at least one CL is integrated in an integrating device such as a rack mount or a blade case.

(11) Moreover, for example, in the present system, when abnormality is generated in each first CL or a first CL has failed, it is possible to perform a maintenance work by operation of the management computer from the administrator or direct operation by using state transmission means provided on each first CL. For example, the system has a function to turn ON, blink, and turn OFF a maintenance lamp.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a configuration of a computer system and its control object computer in embodiments 1 and 5 of the present invention.

FIG. 2 shows a configuration of a computer system in embodiment 2 of the present invention.

FIG. 3 shows a configuration of the computer system in embodiments 3 and 4 of the present invention.

FIG. 4 shows a configuration of the computer system in embodiment 6 of the present invention.

FIG. 5 shows a configuration of the computer system in embodiment 7 of the present invention.

FIG. 6 shows a configuration of the computer system in embodiment 8 of the present invention.

FIG. 7 shows a configuration of the computer system in embodiment 9 of the present invention.

FIG. 8 shows a configuration of the computer system in embodiment 10 of the present invention.

FIG. 9 shows an external configuration of a control object computer (blade) of a computer system in embodiment 11 of the present invention.

FIG. 10 shows an example of processing control sequence in the computer system according to an embodiment of the present invention.

### DETAILED DESCRIPTION OF INVENTION

Description will now be directed to embodiments of the present invention with reference to the attached drawings. It should be noted that in the drawings referred for explanation of the embodiments, like components are denoted by like symbol in principle and their explanations are given once.

In the embodiments of the present invention, the conventional client device is made dual. That is, in addition to a first CL, a portable disk-less terminal device (second CL) is provided to each user. A PC (first PC) operable from the terminal device is stored as a form in which a blade/module type high-density mounting is performed, in a computer room or a data center of an organization of the operation management of the system. The computer room or the like is locked for management so as to prevent intrusion of a third person for assuring a predetermined security. The terminal device includes remote control software communicable with a PC (first CL). Moreover, an identifier is correlated for authenticating a user and a terminal device, and a management server is provided for performing user authentication according to the identifier. The use type is such that the data body used by the user is basically not stored in the terminal device side by the aforementioned user authentication and the remote control software. This prevents data theft and leak and facilitates data operation management. Hereinafter, explanation will be given on specific embodiments having the aforementioned characteristics.

### Embodiment 1

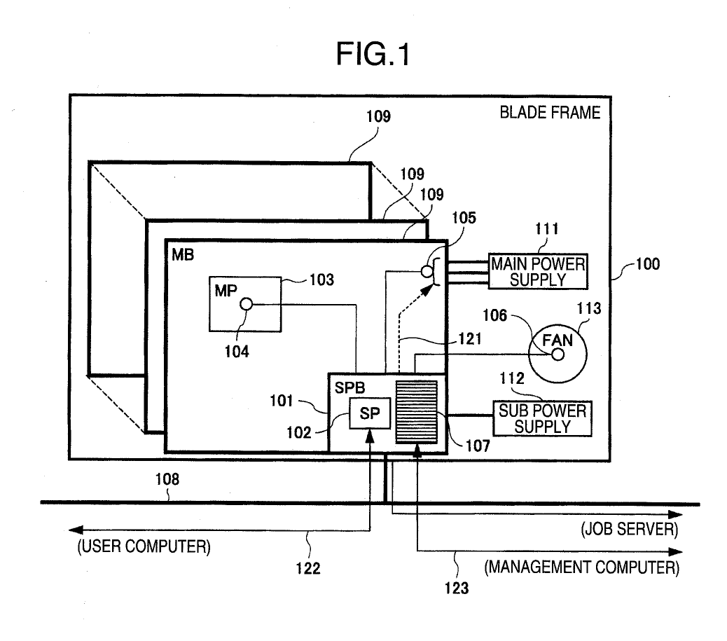

FIG. 1 shows a configuration of a computer system and its control object computer in the first embodiment of the present invention. In the first embodiment, a sub processor is mounted on the user CL device so that remote control can be performed and the first embodiment has a function for reporting an abnormal state of the CL device to an administrator.

In the present system, a blade case 100 having a built in computer (corresponding to the first CL) such as a PC used by the user is connected to a network 108. A user computer (first CL) is a board connected as a main board (MB or base board) 109 to the blade case 100. Each MB 109 has a sub processor board (SPB or MB management board) 101 mounted or connected in the vicinity.

Although not depicted, the network 108 is connected to another computer (corresponding to the second CL) of the user, a job server, an administrator computer (management computer), and the like. Another computer (second CL) of the user and the management computer can communicate with the SPB 101. The network 108 may be configured by a plurality of communication means.

The blade case 100 contains at least one built-in (high-density mounting) PC of each user as a similar type of blade/module MB 109, sharing a power supply system. The blade case 100 includes an MB 109, a main power supply 111, a sub power supply 112, a fan 113, and the like. The MB 109 can be inserted/removed when required. The fan 113 cools components (heating units) such as the MB 109 by air blasting.

The MB 109 includes a main processor (MP) 103, a memory, and an I/F (interface) (not depicted). The MB 109 has an external surface which is covered by a blade type frame, for example. The MP 103 realizes the function as the MP by execution of a program or the like, controls the entire MB 109 (excluding the SPB 101), performs OS and application control/processing, and uses the job server, thereby providing a function and a service according to the user operation.

The SPB 101 includes a sub processor (SP) 102, a nonvolatile memory 107, and a memory and an I/F (not depicted). The SP 102 realizes the function as the SP by executing a program or the like, controls the entire SPB 101, monitors the corresponding MB 109 entirely, and performs a predetermined control. The SP 102 reads and writes data from/to the nonvolatile memory 107 and the data is stored.

As for the power supply configuration, the main power supply 111 supplies power to respective components such as the MP 103 for the MB 109. Moreover, the sub power supply 112 supplies power to the respective components such as the SP 102 for the SPB 101. The sub power supply 112 is always in the ON state. Even when the main power supply 111 is in the OFF state, the power supply is not stopped and power is always supplied to the SPB 101. The main power supply 111 can be operated/controlled to be ON/OFF from the SPB 101 by the main power supply control signal (and its line) 121.

A temperature sensor 104 is provided in the vicinity of the MP 103 so as to detect the temperature of the MP 103. A power supply sensor 105 is provided for the line from the main power supply 111 so as to detect the power supply state of the main power supply 111. A fan sensor 106 checks and detects the rotation state of the fan 113.

In the SPB 101, the SP 102 monitors the states of respective sensors (104 to 106) all the time so as to detect an abnormal state of the MB 109. For example, when detection of these sensors (104 to 106) has found an observation value significantly apart from a pre-specified/set value and condition, the SP 102 records error information, i.e., information indicating abnormality of the state as an event in the nonvolatile memory 107 on the SPB 101.

The administrator is an administrator of the present system or a computer of a plurality of users. The administrator checks the content, i.e., error information in the nonvolatile memory 107 on the SPB 101, thereby knowing the occurrence of an abnormal state and performing a predetermined countermeasure for this.

The processing style is not limited to access from the management computer side but it is also possible to access the management computer from the SPB 101. For example, depending on the program configuration in the SPB 101, if an abnormal value occurs, this may be reported by an e-mail sent to the management computer.

When the SPB 101 detects an abnormal state during monitoring, this is reported to the management computer and the user computer (second CL) via the network 108 so as to cope with the abnormal state. That is, when the SP 102 has found abnormal supply of the main power supply 111, a high temperature of the SP 103, stop of the fan 113, freeze of the OS on the MP 103, or the like, predetermined report means reports the abnormal state to only the management computer or to the management computer and another computer (second CL) of the user. The report means may be lamp ON, a sound generation, an automatic message sending, or the like. It should be noted that the report destination in reporting the abnormal state is set depending on the operation system configured by including the MB 109 (first CL).

The user and the administrator who have received the report, for example, sends control signals (122, 123) to the SPB 101 so as to perform a predetermined countermeasure. From the user computer (second CL), a control signal for remote-controlling the SP 102 and data 122 may be sent/received to the SPB 101 of the MB 109 via the network 108. Similarly, from the management computer, a control signal for communicating with the SP 102 and data 123 may be sent/received to the SPB 101 of the MB 109 via the network 108.

It should be noted that in the present embodiment, the MB 109 as a PC (first CL) of each user is mounted in a single blade case 100, i.e., a plurality of user PC may be integrally managed. However, the first CL (MB 109) may not be contained in the blade case 100. It is possible to provide a system in which a plurality of first CL are integrally connected or they exist as an independent computer (first CL) in individual user unit on the network 108. Since the user can control the MB 109 which is his/her own PC (first CL) from the remote computer (second CL), management is possible even if the user has no change to directly touch the object PC (first CL) like in the present embodiment.

According to the first embodiment, when the state in the MB 109 which is the user computer (first CL) has become abnormal, this may be reported to a remote device and a predetermined countermeasure may be performed, thereby facilitating the computer operation management.

### Embodiment 2

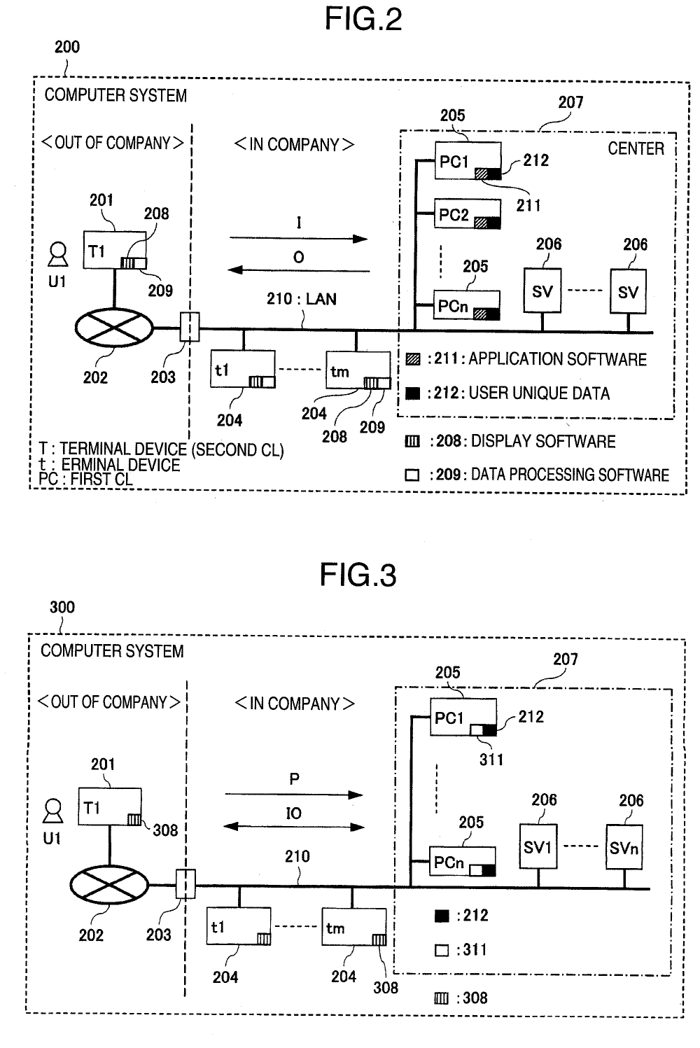

Next, explanation will be given on the second embodiment. FIG. 2 shows a configuration of a computer system according to the second embodiment of the present invention. This computer system 200 is an embodiment having the minimum size. A computer system in a company such as an enterprise, a network (public line network) 202 outside the company, and a terminal device 201 of a user belonging to the enterprise are communicably connected.

The in-company computer system is connected to respective devices around the LAN 210 and a center (computer center/security room) 207 has n PCs (PC1 to PCn) connected to the LAN and used by users and a plurality of servers (SV) 206. Moreover, the in-company system includes m in-company terminal devices (t1 to tm) 204 outside the in-company center 207, so as to be connected to the LAN 210. Moreover, a gateway 203 is provided between the network 202 and the LAN 210. The network 202 is communicably connected to the terminal device (T1) 201 of a user (for example, user U1).

A terminal device (second CL) and a PC (first CL) 205 to be used by each user is allocated for the user in advance. For simplifying explanation, it is assumed that the terminal 201 corresponds to the PC 205 and the PC1 is fixedly allocated for U1, T1. Although not depicted, the same configuration for using the terminal device 201 and the PC 205 can be obtained for a plurality of other users.

In the present embodiment, data (unique data of each user) 212 is stored in the PC 205. The user (U1) and its terminal device (T1) 201 accesses its PC (PC1) via the gateway 203 of the organization to which the user belongs using the network 202.

The PC 205 is a first CL which is allocated for each of users. The PC 205 is installed in the company (in the center 207) and contains application software 211 and data (unique data of respective users) 212.

The terminal device 201 is a second CL for the PC (first CL) 205 of the user. The terminal device 201 is a portable type, can be carried outside the company so that the user can operate at hand, and has a function for making connection to the network 202 when required. However, it is impossible to store the user data 212 in the terminal device 201 at hand of the user.

The terminal device 201 contains data processing software 209 as software (including an OS) for inputting (acquiring/receiving) the data 212 from the PC 205 and processing it. Moreover, the terminal device 201 contains display software 208 for viewing a screen allocated for the user PC 205. The data processing software 209 processes data inputted from the PC 205. The display software 208 displays screen data on the display device of the terminal device 201.

Input information (I) is passed from the terminal device 201 side to the PC 205 side. Moreover, screen information (O) and the like are passed from the PC 205 side to the terminal device 201 side. Thus, the data 212 processed by the application software 211 of the PC 205 can be displayed on the screen of the terminal device 201 by the display software 208 and processed by the data processing software 209.

In addition to the terminal device 201 which can be used by the user outside the company, it is possible to provide a terminal device 204 in the company so that the user uses the terminal device 204 to access the PC 205. Each user can use the job server 206 in the organization by using the user's PC 205 when required. Moreover, when the terminal device 201 is allocated for each of all the staffs in the company, the PC 205 is stored together with the other job server 206 in the center 207 which can be locked to assure a predetermined security, thereby improving data safety against theft.

In the second embodiment, the data created and referenced by the user by using the terminal device 201 at hand is stored as the user data 212 in the remote PC 205. The use environment of the PC 205 allocated for the user can be operated directly by the terminal device 201 at a remote place. Since the user data 212 is not stored in the terminal device 201 outside the company, there is no danger of data/information loss or leak. Especially when the user carries the terminal device 201 and if the terminal device is lost or stolen, the data 212 is physically not outside the company and it is possible to reduce the danger of information leak. Moreover, it is possible to prevent unintentional leak of the data 212.

### Embodiment 3

Next, explanation will be given on the third embodiment. FIG. 3 shows a configuration of a computer system according to the third embodiment of the present invention. The computer system 300 of the third embodiment has basically identical configuration as the second embodiment. Data processing software 311 for processing data and application software exist in the in-company PC 205, where the user data 212 is operated to be processed and stored. In the terminal device 201, display software 308 (corresponding to 208 in the second embodiment) is operating for receiving and displaying screen information from the PC 205. The other data flow and data storage positions are identical to those in the second embodiment. Between the terminal device 201 and the corresponding PC 205, I/O information including screen information is transmitted and received. Moreover, like in the first embodiment and a fifth embodiment, control information and data (P) can be transmitted from the terminal device 201 to the PC 205 for power operation and the like.

The terminal device 201 side has, for example, software for remote control of the PC 205 in addition to the basic OS. The remote control software includes display software 308 (data I/O function) and has the communication function and data input function. The I/O function of the terminal device 201 includes an I/F function of a keyboard, a mouse, a tablet, and other (built-in or external) devices for enabling I/O of characters, audio, and video.

In the third embodiment, it is possible to obtain the same effect as the second embodiment and it is possible to simplify the configuration of the terminal device 201 because no data processing software 311 is provided.

### Embodiment 4

Next, explanation will be given on the fourth embodiment. A computer system according to the fourth embodiment basically has the same configuration as the third embodiment shown in FIG. 3. The OS itself of the terminal device 201 allocated for each of users may also be started by the PC 205 at a remote place. In the fourth embodiment, there is no need of mounting an expensive OS for operating application software on the user terminal device 201. The fourth embodiment only includes so-called remote control software having the screen display function (display software 308) of the user PC 205 and a data input function for sending input information by an input device such as a keyboard. The terminal device 201 is a simplified client device having built-in remote control software for replacing the aforementioned CL device.

According to the fourth embodiment, the user can use the terminal device 201 of simplified configuration and it is possible to build a system at a low cost as compared to the first and second embodiments which require cost of dual (the first CL and the second CL) computers for one user.

### Embodiment 5

Next, explanation will be given on the fifth embodiment. A computer system according to the fifth embodiment of the present invention basically has the same configuration as the first embodiment shown in FIG. 1 and the third embodiment shown in FIG. 3. The fifth embodiment has a function for controlling the power supply state of the first CL from a remote device.

In the computer system of the fifth embodiment, the SP 102 operates a power switch (main power switch 111) of the MB 109 body by a particular packet (control signal 122) via the network 108 by using a control signal 121. This operation has no relation with the OS and application software operating in each MB 109 (PC 205). Accordingly, even if they are frozen/hung-up, it is possible to forcibly turn power off or reset as a device.

Referring to FIG. 1, for example, a user and an administrator who has received report on an abnormal state from the MB 109 sends control signals (122, 123) and the like from the second CL and the management computer to the SPB 101. Thus, it is possible to forcibly turn off the main power supply 111 by the main power supply control signal 121 from the SP 102.

Referring to FIG. 3, the PC 205 corresponds to the MB 109. When the PC 205 is frozen, for example, the user sends a control signal (P) for power operation from the terminal device 201 (second CL) to the PC 205 (first CL) and the PC 205 forcibly turn off the power supply of its body according to the control signal (P).

According to the fifth embodiment, user PC power operation/control is performed, for example, by the SP 102 separated from the MP 103 and even if the OS or application software is frozen/hung-up, it is possible to forcibly turn power OFF from a remote device, thereby facilitating the computer operation management.

### Embodiment 6

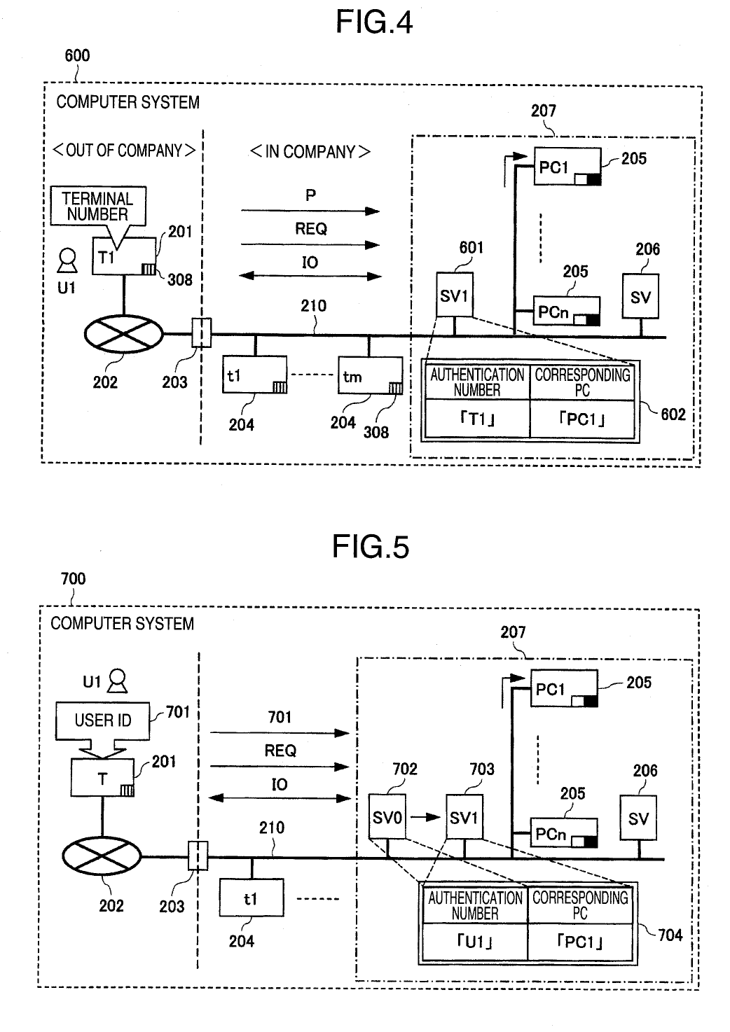

Next, explanation will be given on the sixth embodiment. FIG. 4 shows a configuration of a computer system 600 according to the sixth embodiment of the present invention. The computer system 600 of the sixth embodiment basically has identical configuration to the third embodiment in FIG. 3 and the like. For a connection request made from a remote place by using the management server, the user uses a particular PC 205. In the sixth embodiment, a client (CL) management server 601 (“SV1”) is provided as a pre-stage of the PC 205 group in the company. All the terminal devices 201 send their individual numbers or identifiers (terminal number or the like) to the CL management server 401 in the company so as to perform power operation by the control signal (P) and various requests (REQ) such as a connection request to the PC 205. The individual number here serves as authentication information (authentication number) in the company. Any unique information stored in the terminal device 201 as the client device (second CL) which can be electronically acquired can be used. For example, the information may be a MAC address for connection with the network 202 and the device fabrication number. The CL management server 401 holds a correspondence relationship table 602 as information for managing the computer use by each of users. That is, in the sixth embodiment, the correspondence relationship table 602 includes information on the relationship between the terminal number serving as the authentication number and the corresponding PC (connection destination PC 205) corresponding to the authentication number.

When the CL management server 601 receives various requests (REQ) with a terminal number (such as “T1”) from a user and the terminal device 201 side, especially upon reception of the connection request to the PC 205, the CL management server 601 references the correspondence relationship table 602 to perform authentication by the terminal number of the terminal device 201 and searches for the PC 205 as the connection destination allocated for the terminal device 201. The request from the terminal device 201 side is sent to the corresponding PC 205 (such as “PC1”). In other words, the CL management server 601 relays communication between the terminal device 201 and the PC 205. This enables the user of the terminal device 201 to use the PC 205.

It is also possible to arrange one or more management computers to be used by the administrator on the network such as the LAN 210. In FIG. 4, as the management computer, the CL management server 601 is provided. Moreover, according to the setting of allocation in the correspondence relationship table 602, it is possible to connect a plurality of PC 205 (first CL) to one terminal device 201 (second CL) or connect one PC 205 to a plurality of terminal devices 201 of one user.

According to the sixth embodiment, when a connection request is made from the terminal device 201 to the corresponding PC 205, the CL management server 601 performs user authentication so as to prevent unauthorized access to the PC 205 and assure high safety.

### Embodiment 7

Next, explanation will be given on the seventh embodiment. FIG. 5 shows a configuration of a computer system 700 according to the seventh embodiment of the present invention. The computer system 700 of the seventh embodiment basically has the same configuration as the embodiment 5 shown in FIG. 4. In the seventh embodiment, an authentication server 702 (“SV0”) and a CL management server 703 (“SV1”) are provided as management computers at the pre-stage of the PC 205 in the company. All the terminal devices 201 (“T”) hold or correlate identifiers (user ID) 701 for recognizing individual users using the terminal devices 201. The identifier 701 may be realized by card as a portable medium, a password, biometrics authentication information, hardware dongle, or the like. When communicating with the PC 205 side, the terminal device 201 passes the information including its user ID 701 (such as “U1”) to the authentication server 501 in the organization. Thus, the authentication server 501 recognizes the user by authentication using the user ID 701, i.e., comparison check using a correspondence relationship table 704 and causes the CL management server 703 to make a connection to the PC 205 (such as “PC1”) as a connection destination corresponding to the user for operation/use. If the user ID 701 does not coincide with the corresponding identifier in the authentication, connection is not allowed, thereby preventing an unauthorized use of the PC 205. The authentication server 702 and the CL management server 793 performs various processes by referencing the correspondence relationship table 704 like in the sixth embodiment. The correspondence relationship table 704 holds information equivalent to the user ID 701 as an authentication number. It should be noted that when the authentication number as the authentication information does not include the identifier (terminal number) of the terminal device 201 like in the sixth embodiment, a user can operate/use his/her PC 205 by using any one of the terminal devices 201 of a plurality of users.

According to the sixth or the seventh embodiment, a user need not carry the PC 205 or the terminal device 201, which further improve the security.

### Embodiment 8

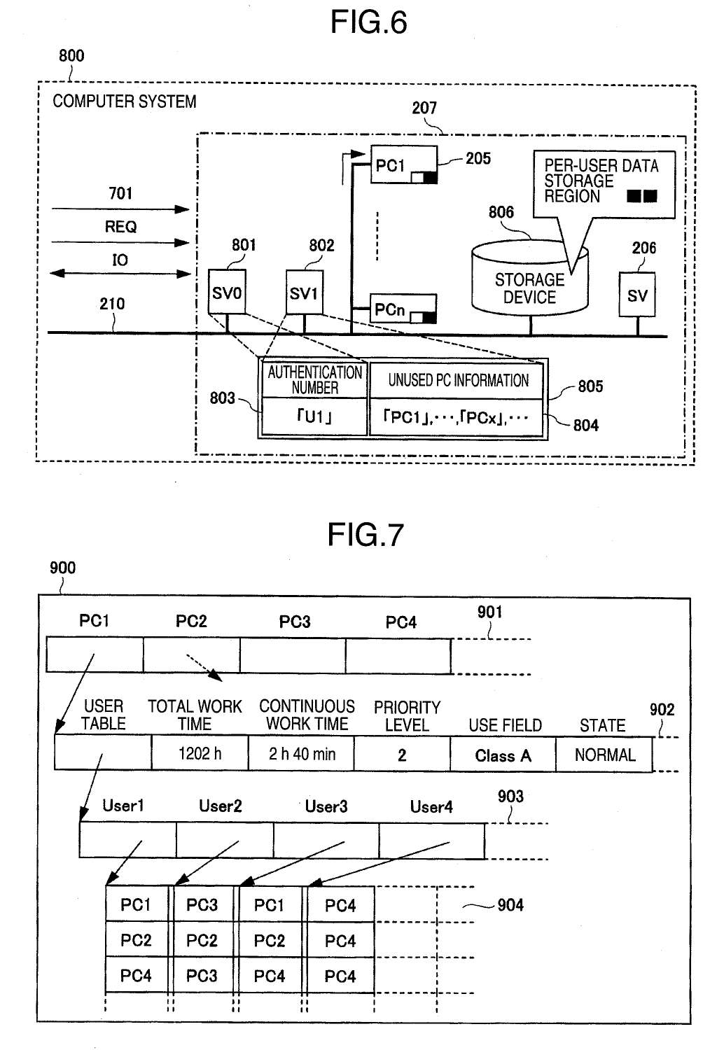

Next, explanation will be given on the eighth embodiment. FIG. 6 shows a configuration of a computer system 800 according to the eight embodiment. The computer system 800 of the eighth embodiment basically has the same configuration as the seventh embodiment shown in FIG. 5. A particular computer is not allocated and connected/started for each of the users and an arbitrary empty PC 205 is provided. The terminal device 201 (second CL) side is omitted in the figure. In the eighth embodiment, the computer system 800 includes an authentication server 801 and a PC management server 802 holding a management table (correspondence relationship table) 805 for managing whether each of the PC 205 in the organization to be managed can be used, as management computers at the pre-stage of the PC 205 group in the company. Moreover, the computer system 800 includes a storage device 806 having a per-user data storage region holding data (212) of each user which is connected to the common network (21) to be shared.

When a terminal device 201 (second CL) directly operated by each user makes a connection request (REQ) for using (connecting) the PC 205 of a certain user (such as “U1”), firstly, an authentication server 801 performing authentication of the user judges whether the user is an authorized user by comparing an identifier such as a user ID 701 from the terminal device 201 side to the authentication number 803 in the correspondence relationship table 805. Next, the PC management server 802 receives the connection request (REQ), references unused PC information 804 in the correspondence relationship table 805, and selects/searches for a PC 205 in an unused state. When an unused (not used by another user) PC 205 (such as “PC1”) exists, the PC 205 is connected to (allocated for) the terminal device 201 of the user (U1). When more than one PC 205 which can be used exist, one of them is selected for use.

Furthermore, for the data (212) used/held by the user from the terminal device 201, an environment as follows is provided. That is, by combining it with use in the PC 205, the data can be acquired from the per-user data storage region of the storage device 806 or stored. For example, user data (212) may be concentratedly stored only in the storage device (806). The administrator performs management (backup, maintenance, capacity limit, etc.) of the storage device 806, thereby assuring safety of the data (212).

According to the eighth embodiment, the PC management server 802 enables a user to flexibly use a computer without fixing a particular computer combination (first CL-second CL) for each user. Moreover, since the user unique data (212) is held in the common storage medium (806), management is simplified.

### Embodiment 9

Next, explanation will be given on the ninth embodiment. FIG. 7 shows an example of configuration of a management table 900 in a computer system of the ninth embodiment of the present invention. The computer system of the ninth embodiment basically has the same configuration as the aforementioned embodiments. For the computer to be allocated for each user, a management computer selects a connection destination according to a policy. The management computer (such as the CL management server 601) electronically holds the management table 900 of the structure shown in FIG. 7.

The management table 900 has a PC management table 901, a policy management table (management item table) 902, a user table 903, a use frequency table 904, and the like. The PC management table 901 manages the PC 205 group (“PC1”, . . . ) as a plurality of first CL in the range (organization) to be managed.

The policy table 902 lists the items to be managed as policy setting management by the system and contains pointers specifying tables (sub tables) of the respective items. By increasing the number of items in the policy table 902, it is possible to accurately set the “policy”. The “policy” information is used to judge allocation/correspondence relationship in the user, terminal device 201, the PC 205, and the like. The items of the policy table 902 may be, for example, a user table 903, total labor time, continuous labor time, priority level, use field, and a state (normal/abnormal state of the PC 205).

For example, the user table 903 is a list of users who can use the computer (PC 205). When an inquiry is made from the user side about a connection request destination, the management computer references this table and judges whether use is enabled/disabled. Moreover, the user table 903 may further manage the use frequency table 904 per user (“User1”, . . . ). The use frequency table 904 records which of the PC 205 is used. When the user does not specify a device to be used, the management computer references the use frequency 904 of the user and allows use if no other problem is present and connects the PC 2-5 (unused or having small load) to the user terminal device 201.

The administrator of the organization operating the system can know the estimated service life of each computer (PC 205) from the policy table 902 and can control the operation time according to the continuous operation time and the priority level (set value for allocation control with a higher priority) in the table. Moreover, by setting the use field, it is possible to reserve the use with a higher priority based on the lesson schedule at school or set a higher priority for a particular teacher to always use the PC 205.

The administrator or the like sets at least one policy item as follows in the management computer for making judgment when selecting/deciding the PC 205 (first CL) to be used by the user. The management computer selects at least one unused PC 205 (first CL) for the terminal device 201 of the user who has made a connection request (REQ) and connects it for use. The policy may be as follows: (1) Only one or several users decided in advance can use all the first CL to be managed; (2) selection/specification is made so that the operation times of all the first CL to be managed are identical; (3) for the first CL whose power ON time (continuous operation time) is long, the power supply is stopped if a time idle state defined separately has continued; (4) allocation priority of the first CL to be managed is specified in advance; (5) the first CL to be managed is classified into groups according to their use object and use field; (6) the first CL to be managed are divided according to the user priority; (7) users of the first CL to be managed are connected to the same first CL if possible; and (8) a first CL in which any error is detected is excluded from candidates for operation.

According to the ninth embodiment, by setting a policy, it is possible to perform more flexible and accurate computer operation management.

### Embodiment 10

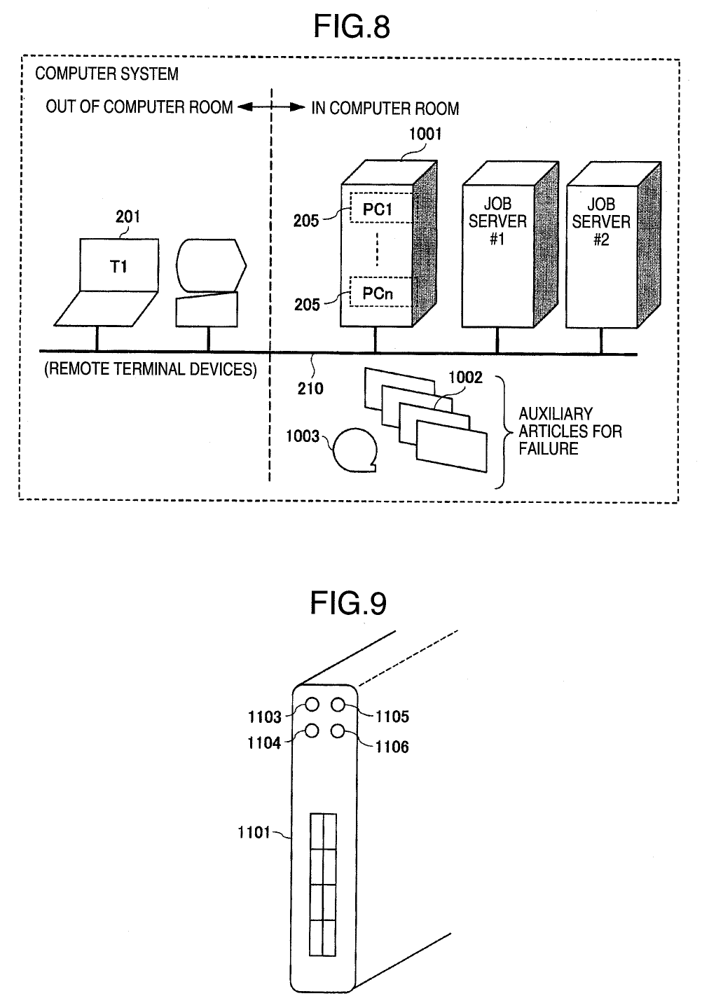

Next, explanation will be given on the tenth embodiment. FIG. 8 shows a configuration of a computer system according to the tenth embodiment of the present invention. The computer system of the tenth embodiment basically has the same configuration as the aforementioned embodiments. All or a plurality of first CL to be managed are installed in a blade/module type high-density mounting PC (integrated device) 1001 like in FIG. 1. Each of the PC 205 is mounted (inserted/removed) on the integrated device 1001 in a standardized type, i.e., the blade form such as the MB 109 having the SPB 101. The integrated device 1001 is installed in a computer room (center 208) or the like and the PC 205 of the blade form can be used from each remote terminal device outside the computer room. This can minimize an auxiliary blade 1002 and an organization master 1003 (media for recovery such as OS and application) as articles for coping with a failure (security parts). When the blade has failed, the user data (212) stored in an HDD or the like requires data transfer but the replacement can be completed before a service arrives since the blade is a security part. Moreover, it is possible to reduce the number of types of the master file (organization master 1003) used by the organization, which facilitates management. Moreover, when the aforementioned eighth embodiment is used in combination, the user data (212) can easily be recovered by using the storage device 806. The computer room may be provided and managed by a specialist outside the company.

According to the tenth embodiment, it is possible to further simplify the management by integration and improve maintenance by the administrator. Moreover, by locking the integrated device or storing it in the locked management room (computer room), it is possible to prevent theft of the PC 205 and its internal data (212).

### Embodiment 11

Next, explanation will be given on the eleventh embodiment. FIG. 9 shows a configuration of external view (front view) of a blade 1101 which is a first CL in a computer system of the eleventh embodiment of the present invention. The computer system of the eleventh embodiment basically has the same configuration as the aforementioned embodiments. The computers (each of PC 205) to be managed are standardized into compact devices having means for facilitating to distinguish an object of maintenance. The blade 1101 has the same configuration as the one shown in FIG. 1 and the like.

Each of the blades 1101 has, on its external surface, display means such as a light emitting diode (LED), alarm (sounding) means, and other means for identification/state-transmission for blade maintenance management. The administrator uses the means to identify a blade 1101 from the management computer (CL management server 601 or the like) connecting/managing the terminal device 201 (second CL) to the first CL. The means may be realized, for example, by a lamp which can be controlled from outside. When abnormality has occurred in each of the first CL, the administrator can turn ON or blink the maintenance lamp by control operation from the management computer or by direct operation, so as to transmit the state of a specific blade 1101.

On the front surface of the blade 1101, there are provided a power lamp 1103 (indicating the power supply state), a status lamp 1104 (indicating the state), and a LAN connection lamp 1105 (indicating the communication connection state) by LED, for example. Moreover, a position lamp 1106 which can be manually turned ON is provided. The position lamp 1106 can be turned ON/OFF by control from the management computer or by direct operation regardless of the program processing state in the blade 1101 device. By using this lamp, it is possible to accurately search for a specific blade 1101 requiring a work by the administrator (such as maintenance exchange) from a plenty of blades 1101 arranged in a device (blade case 100 or integrated device 1001) and prevent a mistake of pulling out an incorrect blade at the right or the left of the blade 1101 requiring maintenance, thereby facilitating the computer operation management.

<Processing Control Example>

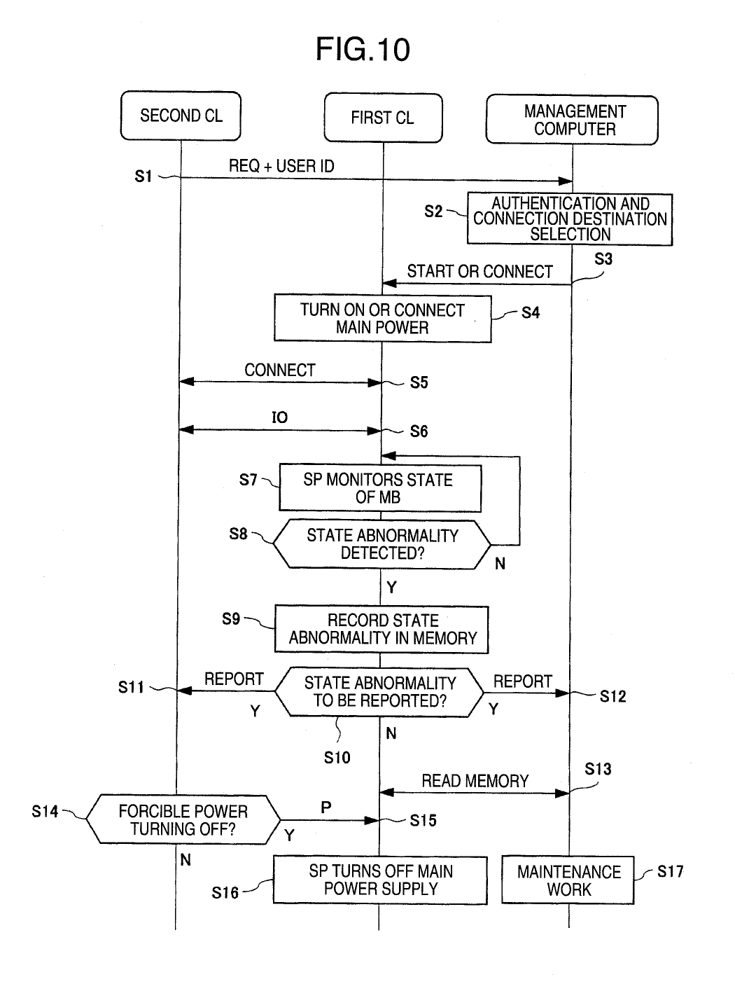

Next, FIG. 10 shows an example of processing control in the computer system according to the first embodiment of the present invention. In this example, the system uses the aforementioned embodiments (1 to 11) in combination. Firstly, in S1 (hereinafter, S represents a processing step), a connection request (REQ) and a user ID 701 are sent from a terminal device (such as T1) 201 as the second CL of a user (such as U1) to a PC 205 (configured by the blade 1101 of the MB 109 having the SPB 101) as the first CL. Next, in S2, the management computer (configured by at least one management server) performs authentication for connection/use and selection of the connection destination PC 205 in accordance with the policy setting and the like. Next, in S3, the management computer starts the PC 205 (such as PC1) as the connection destination or makes a connection with it. In S4, the PC 205 is started by turning ON of the main power supply 111 or if already started, connected to the terminal device 201. In S5, the terminal device 201 and the connection destination PC 205 perform a connection process. In S6, data is inputted and outputted between the terminal device 201 and the connection destination PC 205. The user data 212 which has been processed is stored in the PC 205 or the storage device 806.

Moreover, in S7, in the first CL, the SP 102 monitors each state of the MB 109 by the sensor. If any abnormal state is detected in S8, the SP 102 describes the state abnormality in the nonvolatile memory 107 in S9. Moreover, in S10, when the state abnormality is to be reported, the state abnormality is reported to the management computer and the user terminal device 201 as the report destinations in S11 and S12.

On the other hand, the terminal device 201 and the user recognizes the state abnormality of the second CL by the report (S11). Moreover, the management computer and the administrator recognize the state abnormality of the second CL by the report (S12) or by reading the contents of the nonvolatile memory 107 of the SPB 101 in S13.

In S14, the terminal device 201 and the user can instruct forcible power turn OFF or reset to the SBP 101 to cope with the state abnormality. In this case, an instruction is made by using a control signal (P) to the SP 102. In S16, the SP 102 causes the main power supply 111 to be turned OFF. Moreover, the management computer and the administrator can rapidly execute a predetermined maintenance work in S18. The power control identical to the second CL may also be executed from the management computer side.

According to the aforementioned embodiments, it is possible to cope with data/information loss and leak caused by movement of the client device. Moreover, the management of the computer used is simplified. Moreover, it is possible to perform a lending work of a client device having respective characteristics (providing the computer operation management system). Especially data centers which have been conventionally performing lending/management work of server devices can lend a client environment and providing a maintenance service as a new job field.

The present invention has thus far been described through the specific embodiments. However, the present invention is not to be limited to the aforementioned embodiments. The present invention can be modified in various ways without departing from the spirit of the invention.

The present invention may be effectively applied to computer systems in general, especially to jobs using mobile PC which may be carried out such as general office work in various job types including schools, government and other public offices, business concerns, manufacturing industry, and the like.

Among the inventions disclosed in the present application, the effect obtained by the representative invention is as follows. The present invention provides a technique of the computer operation management for coping with data loss and leak by movement of the client device and facilitating management of the computer used.

1. A computer system including first computers, each of which is allocated for one user and comprises:
a main processor;
a sub processor for monitoring a state of the first computer including the main processor;
monitoring means for monitoring states of power supply, temperature, and functional failure in the first computer by the sub processor; and
means used when state abnormality is detected in the states by the monitoring means, for reporting the state abnormality to a management computer communicably connected to the sub processor or to each of the management computer and a second computer used by the user and communicably connected to the sub processor at a remote place.

2. A computer system including first computers, at least one of which is allocated for one user to be used for a job of the user and connected to a network; wherein
each of the first computers includes a main processor, and a sub processor for monitoring a state of the first computer including the main processor,
the computer system comprises a terminal device communicably connected to the first computer via the network for use by the user, and
the user uses an environment of the first computer allocated for the user from the terminal device at a remote place, and user data created and referenced by the user by using the terminal device is stored in the first computer at the remote place and not stored in the terminal device.

3. The computer system as claimed in claim 2, wherein
an application program to be used by the user on the terminal device at hand is operated on the first computer allocated for the user at a remote place, and
the terminal device includes an operating system and I/O means for outputting information from the first computer at a remote place including display of the screen information and inputting information from the terminal device at hand to the first computer.

4. The computer system as claimed in claim 2, wherein
an operating system to be operated by the user on the terminal device at hand is operated on the first computer allocated for the user at a remote place, and
the terminal device includes a built-in remote control software program for operating and data-transferring information output including display of screen information from the first computer and information input from the terminal device at hand to the first computer via the network.

5. The computer system as claimed in claim 1, the computer system comprising a second computer used by the user and communicably connected to the first computer at a remote place, wherein
the first computer includes a main power supply for supplying power to the main processor and a sub power supply for supplying power to the sub processor,
the sub processor always operates by an ON state of the sub power supply even when the main processor is in a halt state by power OFF of the main power supply, and
for the main power supply, means is provided for sending a control signal from the second computer to the sub processor of the first computer according to a user instruction and forcibly turning ON/OFF the main power supply by controlling the main power supply from the sub processor.

6. A computer system including first computers, at least one of which is allocated for one user to be used for a job of the user and connected to a network, the computer system comprising:
a second computer communicably connected to the first computers via the network at a remote place and used by the user, and
one or more management computers connected to the network,
wherein each of the first computers includes a main processor, a sub processor for monitoring a state of the first computers including the main processor, and monitoring means for monitoring each state in the first computer by the sub processor,
the second computer includes software for using an environment of the first computer allocated for the user at a remote place via the network,
the management computer has a correspondence relationship table indicating correspondence relationship between each user and a first computer allocated for the user and
means for referencing the correspondence relationship table in response to a connection request from the second computer used by the user computer, and connecting or allowing connection of the second computer of the user to the first computer allocated for the user, so that the user can use the first computer.

7. The computer system as claimed in claim 6, wherein the management computer has the correspondence relationship table containing an identifier of the user and when the user makes a connection request, check is made whether an identifier given from the second computer side of the user coincides with the identifier held in the correspondence relationship table.

8. A computer system including first computers, at least one of which is allocated for one user to be used for a job of the user and connected to a network, the system comprising:
a second computer communicably connected to the first computers via the network at a remote place and used by the user, and
one or more management computers connected to the network,
wherein each of the first computers includes a main processor, a sub processor for monitoring a state of the first computers including the main processor, and monitoring means for monitoring each state in the first computer by the sub processor,
the second computer includes software for using an environment of the first computer allocated for the user at a remote place via the network,
the management computer has a correspondence relationship table indicating correspondence relationship between each user and a first computer allocated for the user and flexibly manages allocation combination between the first computer and the second computer for each user without fixing the combination,
user data for each of the users created and referenced by the user is stored in a common storage medium on the network, and
the management computer which has received a connection request from the second computer of the user allocates the first computer not being used by another user at the moment to the user and connects or allows connection of the first computer to the second computer.

9. The computer system as claimed in claim 8, wherein the management computer includes means for setting at least one policy item as an allocation judgment reference between the user, the second computer, and the first computer,
when the management computer selects the first computer to be allocated for the second computer of the user, the management computer decides to select the first computer by referencing the at least one policy setting and connects it to the second computer of the user, so that the user can use it.

10. The computer system as claimed in claim 1, wherein
the first computers are standardized and the one or more first computers are integrated in an integrating device, and
the integrating device can be locked or arranged in a management room which can be locked.

11. The computer system as claimed in claim 6, wherein
a management computer used by an administrator is communicably connected to the first computers, and
when abnormality or a failure has occurred in the first computer, the state transmission means of the first computer is operated to be controlled by control from the management computer or directly operated by the administrator, thereby transmitting the state of a specific first computer to the administrator.
